(19) United States
(12) Patent Application Publication
(10) Pub. No.: US 2019/0102902 A1
(43) Pub. Date: Apr. 4, 2019

(54) SYSTEM AND METHOD FOR OBJECT DETECTION

(71) Applicant: Caterpillar Inc., Peoria, IL (US)

(72) Inventors: Lawrence Andrew Mianzo, Pittsburgh, PA (US); Michael Hoffelder, Norwich, NY (US); Jeffrey Thomas Stringer, Pittsburgh, PA (US)

(73) Assignee: Caterpillar Inc., Peoria, IL (US)

(21) Appl. No.: 15/723,293

(22) Filed: Oct. 3, 2017

(51) Int. Cl. G06T 7/70; G06T 7/80

(52) U.S. Cl. CPC G06T 7/70; B60Q 9/00; G06T 2207/30196; G06T 7/80

(57) ABSTRACT

A method for detecting an object in an environment of a machine is provided. The method includes determining a first height of the object by applying sliding window detection process on an image. The method determines a score indicating a probability that the object detected in the image matches a predefined set of characteristics. The method further includes determining a minimum and a maximum vertical pixel associated with the object. The method includes determining a second height of the object based on a range of the object, the minimum vertical pixel, the maximum vertical pixel, intrinsic and extrinsic calibration parameters of the image capturing device. The method includes comparing the first height with the second height and accordingly, modifying the score regarding the detection of the object in the image based on whether a difference between the first height and the second height meets a predetermined criterion.

### TECHNICAL FIELD

The present disclosure relates to a system and a method for detecting objects. More specifically, the present disclosure relates to the system and the method for detecting objects in an environment of a machine.

### BACKGROUND

Machines such as, for example, wheel loaders, off-highway haul trucks, excavators, motor graders, and other types of earth-moving machines are used to perform a variety of tasks. Some of these tasks involve intermittently moving between and stopping at certain locations within a worksite. The worksites may have various objects that may provide hindrance in the movement of the machines within the worksite. The objects may comprise human, animals or other objects such as another machine, vehicles, tree, etc.

Generally, the machines have on board image capturing devices that may generate images of the environment of the machines. These images are processed by a controller, based on conventional object detection processes, which detects the presence of such objects in the environment of the machine. However, the conventional processes may result in a missed detection of the object or a false alarm about the presence of the object. The missed detection by the controller means that the object is not detected in the image and the false alarm means that the controller has detected the object, but the object is actually not present in the environment of the machine. The missed detection by the controller may lead to safety issues, while the false alarm may lead to operational and efficiency issues associated with the machine.

U.S. Pat. No. 9,524,426 (hereinafter the '426 reference) describes a human monitoring system that includes a plurality of cameras and a visual processor. The plurality of cameras are disposed about a workspace area, where each camera may capture a video feed that includes a plurality of image frames, and the plurality of image frames are time-synchronized between the respective cameras. The visual processor receives the plurality of image frames from the plurality of vision-based imaging devices and may detect the presence of a human from at least one of the plurality of image frames using pattern matching performed on an input image. The input image to the pattern matching is a sliding window portion of the image frame that is aligned with a rectified coordinate system such that a vertical axis in the workspace area is aligned with a vertical axis of the input image. However, the '426 reference, provides the detection information relying mainly on sliding window process which may lead to false alarm about the object detection in the image.

### SUMMARY

In an aspect of the present disclosure, a method for detecting an object in an environment of a machine is provided. The method comprises capturing, through an image capturing device, an image of the environment of the machine. The method comprises receiving, using a controller, the image of the environment of the machine from the image capturing device. The method further comprises receiving, using the controller, one or more internal parameters associated with an intrinsic calibration of the image capturing device. The method also comprises receiving, using the controller, one or more external parameters associated with an extrinsic calibration of the image capturing device. The method comprises applying, through the controller, an object detection process on one or more scaled versions of the image to detect the object and to determine a score indicating a probability that the object detected in the image matches a predefined set of characteristics. The method comprises determining, through the controller, a scale of the image in which the object is detected. The method comprises determining, through the controller, a first height of the object based on the scale of the image in which the object is detected. The method comprises determining, through the controller, a bounding box comprising a group of pixels defining the object detected in the image. The method comprises determining, through the controller, a minimum vertical pixel and a maximum vertical pixel associated with the object based on the group of pixels within the bounding box. The method comprises determining, through the controller, a range of the object based on the minimum vertical pixel, the one or more internal parameters and the one or more external parameters. The method comprises determining, through the controller, a second height of the object based on the range, the minimum vertical pixel, the maximum vertical pixel, the one or more internal parameters and the one or more external parameters. The method comprises comparing, through the controller, the first height with the second height. The method comprises modifying, through the controller, the score based on whether a difference between the first height and the second height meets a predetermined criterion.

In another aspect of the present disclosure, an object detection system for detecting the object in the environment of the machine is disclosed. The object detection system comprises the image capturing device configured to capture the image of the environment of the machine. The object detection system comprises the controller communicably coupled to the image capturing device. The controller is configured to receive the image of the environment of the machine from the image capturing device. The controller is configured to receive the one or more internal of parameters associated with the intrinsic calibration of the image capturing device. The controller is configured to receive the one or more external parameters associated with the extrinsic calibration of the image capturing device. The controller is configured to apply the object detection process on one or more scaled versions of the image to detect the object and to determine the score indicating a probability that the object detected in the image matches a predefined set of characteristics. The controller is configured to determine the scale of the image in which the object is detected. The controller is configured to determine the first height of the object based on the scale of the image in which the object is detected. The controller is configured to determine the bounding box comprising a group of pixels defining the object detected in the image. The controller is configured to determine the minimum vertical pixel and the maximum vertical pixel associated with the object based on the group of pixels within the bounding box. The controller is configured to determine the range of the object based on the minimum vertical pixel, the one or more internal parameters and the one or more external parameters. The controller is configured to determine the second height of the object based on the range, the minimum vertical pixel, the maximum vertical pixel, the one or more internal parameters and the one or more external parameters. The controller is configured to compare the first height with the second height. The controller is configured to modify the score based on whether the difference between the first height and the second height meets a predetermined criterion.

In yet another aspect of the present disclosure, a machine is disclosed. The machine comprises an upper swiveling body, a ground engaging element coupled to the upper swiveling body, and an engine to provide power to propel the machine. The machine further comprises an image capturing device configured to capture the image of the environment of the machine, wherein the image capturing device is located on the machine. The machine comprises a display configured to display the image of the environment of the machine. The machine comprises the controller communicably coupled to the image capturing device. The controller is configured to receive the image of the environment of the machine from the image capturing device. The controller is configured to receive the one or more internal of parameters associated with the intrinsic calibration of the image capturing device. The controller is configured to receive the one or more external parameters associated with the extrinsic calibration of the image capturing device. The controller is configured to apply the object detection process on one or more scaled versions of the image to detect the object and to determine the score indicating a probability that the object detected in the image matches a predefined set of characteristics. The controller is configured to determine the scale of the image in which the object is detected. The controller is configured to determine the first height of the object based on the scale of the image in which the object is detected. The controller is configured to determine the bounding box comprising a group of pixels defining the object detected in the image. The controller is configured to determine the minimum vertical pixel and the maximum vertical pixel associated with the object based on the group of pixels within the bounding box. The controller is configured to determine the range of the object based on the minimum vertical pixel, the one or more internal parameters and the one or more external parameters. The controller is configured to determine the second height of the object based on the range, the minimum vertical pixel, the maximum vertical pixel, the one or more internal parameters and the one or more external parameters. The controller is configured to compare the first height with the second height. The controller is configured to modify the score based on whether the difference between the first height and the second height meets the predetermined criterion.

### BRIEF DESCRIPTION OF DRAWINGS

FIG. 1 shows a perspective view of an exemplary machine, according to an aspect of the present disclosure;

FIG. 2 schematically shows an object detection system for detecting an object in an environment of the machine, according to an aspect of the present disclosure;

FIG. 3 shows a detection module of the object detection system, according to an aspect of the present disclosure;

FIG. 4 shows an image of the environment of the machine captured by an image capturing device, according to an aspect of the present disclosure;

FIG. 5 shows an image pyramid generated using one or more scaled versions of the image, according to an aspect of the present disclosure;

FIG. 6 shows a first height determination module of the object detection system, according to an aspect of the present disclosure;

FIG. 7 shows a bounding box determination module of the object detection system, according to an aspect of the present disclosure;

FIG. 8 shows pixels of the image of the environment of the machine captured by the image capturing device, according to an aspect of the present disclosure;

FIG. 9 shows a range determination module of the object detection system, according to an aspect of the present disclosure;

FIG. 10 shows a calibration system for calibrating the image capturing device, according to an aspect of the present disclosure;

FIG. 11 shows the images having different types of distortion as captured by the image capturing device, according to an aspect of the present disclosure;

FIG. 12 shows a second height determination module of the object detection system, according to an aspect of the present disclosure;

FIG. 13 shows a height comparator of the object detection system, according to an aspect of the present disclosure;

FIG. 14 shows a flow chart of a method of detecting the object in the environment of the machine, according to an aspect of the present disclosure; and

FIG. 15 shows the flow chart of the method of detecting the object in the environment of the machine, according to an aspect of the present disclosure.

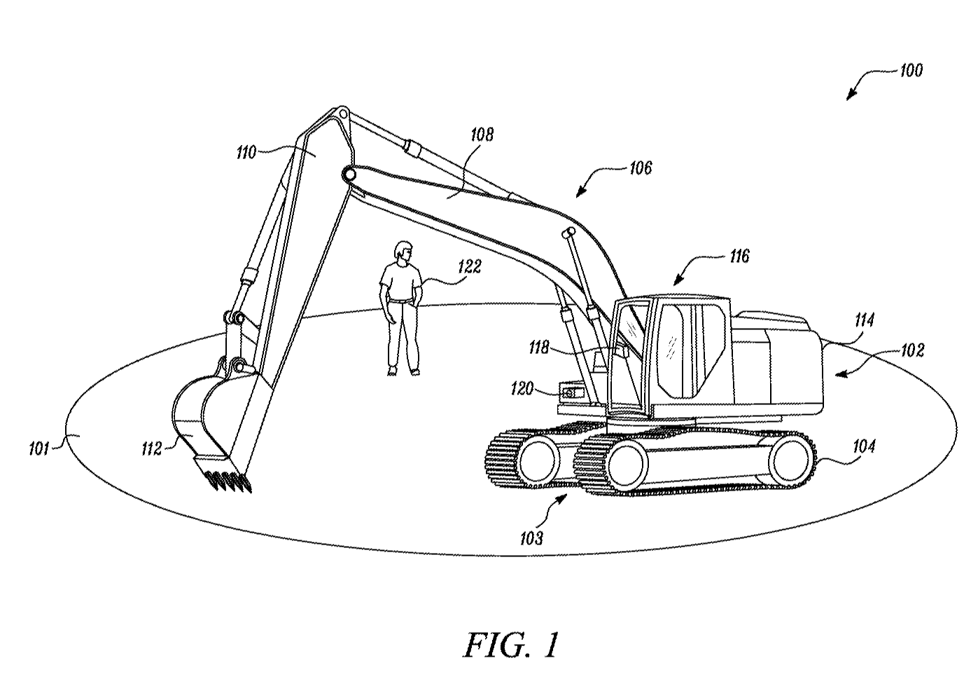

### DETAILED DESCRIPTION

Wherever possible, the same reference numbers will be used throughout the drawings to refer to same or like parts. In an embodiment, FIG. 1 shows an exemplary machine 100 at a worksite 101 at which one or more machines 100 may be operating to perform various tasks. Although, the machine 100 is illustrated as a hydraulic excavator, the machine 100 may be any other type of a work machine, which may perform various operations associated with industries such as mining, construction, farming, transportation, landscaping, or the like. Examples of such machines may comprise a wheel loader, a hydraulic shovel, a dozer, and a dump truck, etc. While the following detailed description describes an exemplary aspect in connection with the hydraulic excavator, it should be appreciated that the description applies equally to the use of the present disclosure in other machines as well.

The machine 100 includes an upper swiveling body 102 supported on an undercarriage assembly 103. The undercarriage assembly 103 may include ground engaging elements 104 such as, for example, tracks that facilitate the movement of the machine 100. The upper swiveling body 102 may be rotated about a generally vertical axis by a hydraulic device, such as a hydraulic motor (not shown), with respect to the undercarriage assembly 103.

The machine 100 further includes a working mechanism 106 for conducting work, such as, for example, to excavate landsides or otherwise to move material. The working mechanism 106 is an excavating mechanism including a boom 108, an arm 110, and a bucket 112, which serves as a front attachment. Additionally, the upper swiveling body 102 may include a counterweight 114 provided at a tail end. The machine 100 includes an engine (not shown) to provide power to propel the machine 100. For example, the engine may provide power to move the ground engaging elements 104 to propel the machine 100.

The machine 100 includes an operator station 116 coupled to the upper swiveling body 102. The operator station 116 includes a display 118 and may comprise other levers or controls for operating the machine 100. The machine 100 further includes an image capturing device 120 to capture an image of an environment of the machine 100. In the illustrated embodiment of FIG. 1, only one image capturing device 120 is shown, however, there may be multiple image capturing devices 120 that may be mounted at different locations on the machine 100. The image capturing device 120 may capture the image including a 360-degree view of the environment of the machine 100.

In the illustrated embodiment, the image capturing device 120 is mounted on the upper swiveling body 102. In one embodiment, the image capturing device 120 is a monocular camera. A monocular camera produces a two-dimensional (2D) image and is a bearing only sensor, meaning it does not provide range information for any object within the image. Embodiments of the image capturing device 120 may comprise cameras that are sensitive to the visual, infrared, or any other portion of the electromagnetic spectrum. In an embodiment, the image capturing device 120 may be a camera capable of capturing both still and moving images. In another embodiment, the image capturing device 120 may comprise a smart camera or a smart vision system having a dedicated on-board processor, including video processing acceleration provided by programmable state array (FPGA), digital signal processor (DSP), general purpose graphics processing unit (GP-GPU), or any other suitable microprocessor with supporting application software. In an embodiment, the image capturing device 120 may be electrically coupled to the display 118 to allow an operator to view the captured image on the display 118.

Further, the worksite 101, on which the machine 100 is operating, may have one or more objects 122. The object 122 may be defined by a set of characteristics such as height, width or other appearance characteristics. In an embodiment, the set of characteristics may be associated with one or more characteristics of a human. In other embodiments, the set of characteristics may be associated with other objects such as, but not limited to, animals, another machine, vehicle, tree, and a portion of the worksite 101, etc. An operator of the machine 100 may need to be informed of such objects 122 in the worksite 101 by means of an alarm or by displaying a warning on the display 118 of the machine 100.

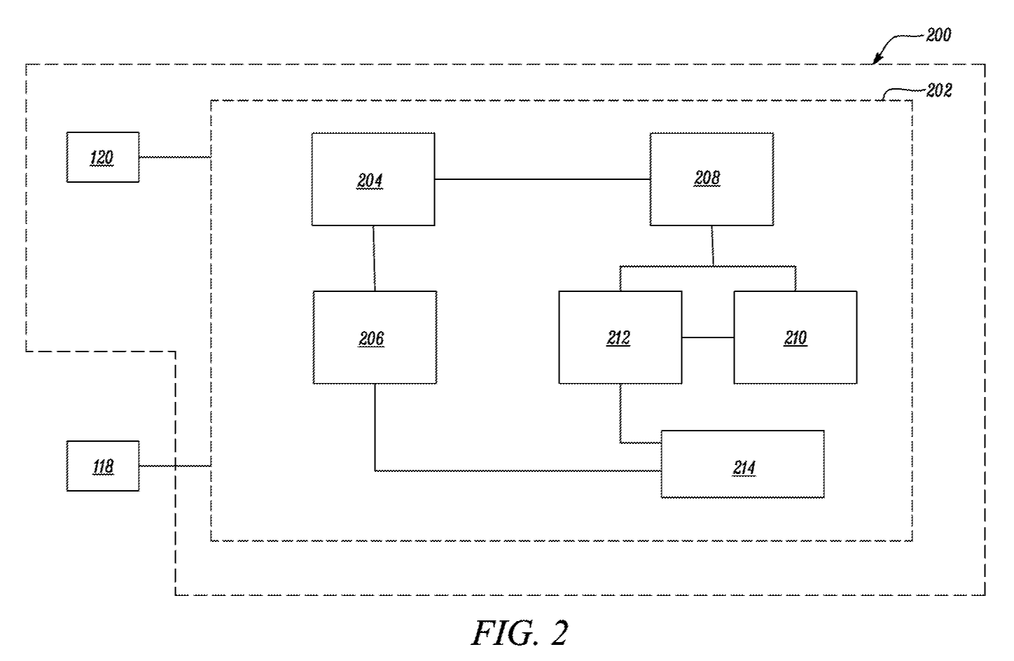

FIG. 2 schematically illustrates an object detection system 200 for detecting the object 122, having a predefined set of characteristics, in the environment of the machine 100. The object detection system 200 includes the image capturing device 120 to capture the image of the environment of the machine 100. The object detection system 200 includes a controller 202 to receive the image of the environment of the machine 100, and subsequently process the image to detect the object 122 having the predefined set of characteristics. The controller 202 further provides a score indicating a probability that the detected object 122 matches the predefined set of characteristics, as explained further in the specification.

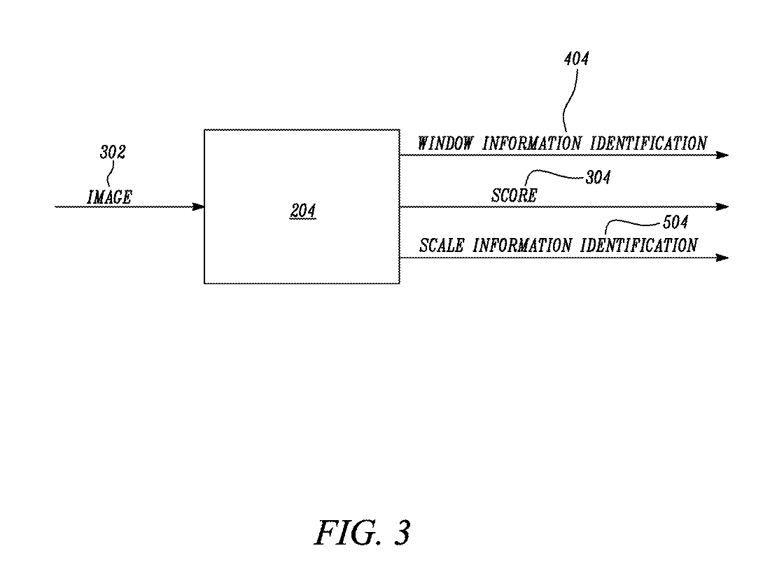

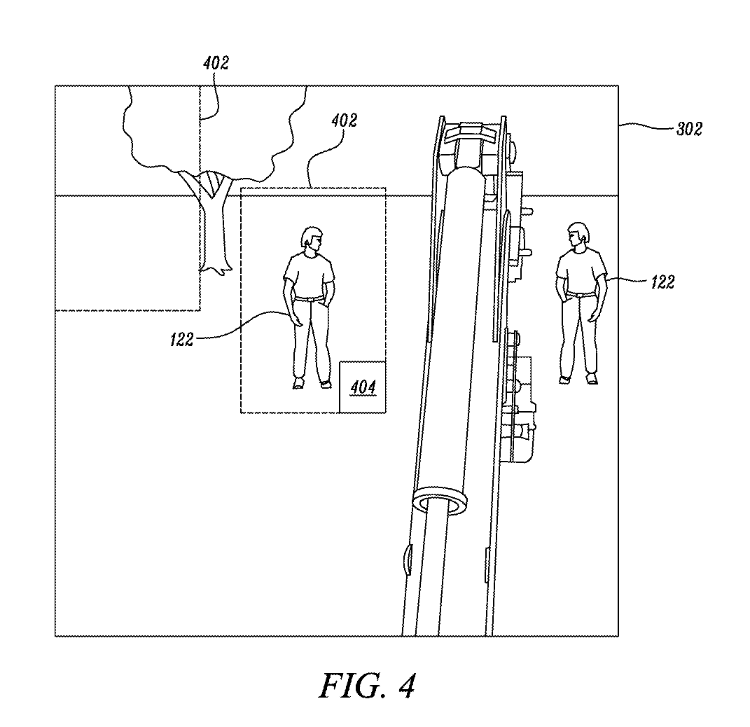

The controller 202 includes a detection module 204 which may use any object detection process to detect a presence of the object 122 in the image. As shown in the exemplary embodiment of FIGS. 3 and 4, the detection module 204 may use sliding-window process, as the object detection process, to detect the object 122 in an image 302 received through the image capturing device 120. The sliding-window process involves using a rectangular detection window 402 of a predetermined size to begin search from a top left region of the image 302 and then sliding the detection window 402 to cover all the regions of the image 302. The size of the detection window 402 may be chosen based on the predefined set of characteristics corresponding to the specific type of the object 122. For example, when the predefined set of characteristics of the object 122 are associated with one or more characteristics of a human, the size of the detection window 402 may be chosen based on a height of the human. Further, the detection module 204 may associate a window information identification 404 with each of the detection windows 402 in which the object 122 is detected. The window information identification 404 may comprise size, location and other characteristics of the detection windows 402 used for searching the various regions of the image 302 based on whether the object 122 is detected.

The detection module 204 is further configured to determine a score 304 indicating a probability that the object 122, that is detected in the image 302, matches the predefined set of characteristics. The detection module 204 may use the score 304 to classify the detection windows 402 as relevant or irrelevant depending on whether the detection window 402 includes the object 122 matching the predefined set of characteristics.

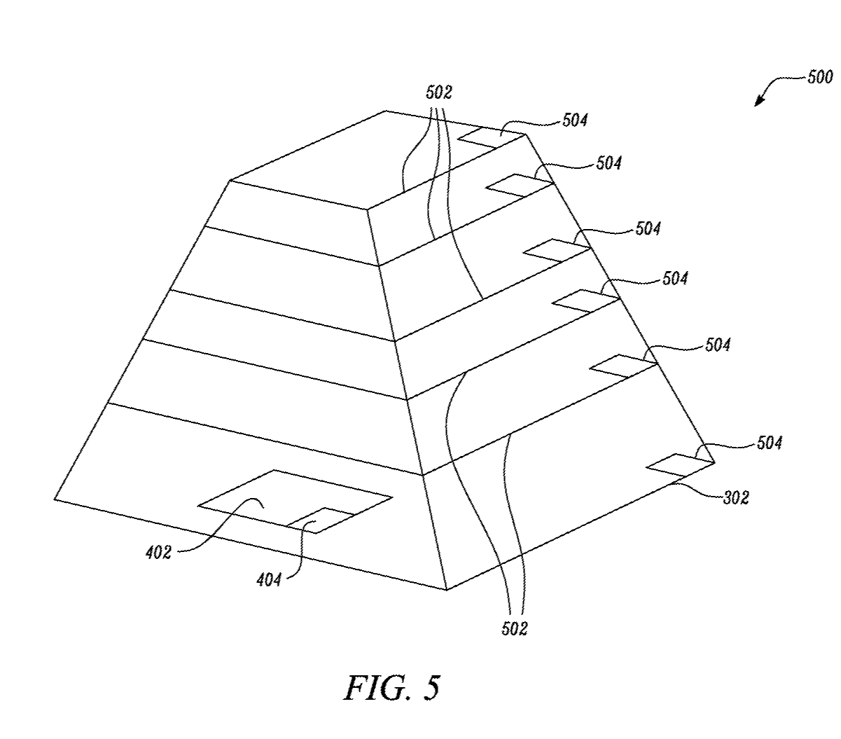

Furthermore, the detection module 204 may use the sliding window process on one or more scaled versions of the image 302. As shown in FIG. 5, an image pyramid 500 represents the multiple scaled-down versions of the image 302. At the bottom of the image pyramid 500, the original image 302 is present in its original size (in terms of width and height). At each subsequent layer, the image 302 is scaled-down and optionally smoothed using, for example, Gaussian blurring. The image pyramid 500 allows the sliding window detection process to detect the object 122 at different scales 502 of the image 302. The detection module 204 may provide a scale information identification 504 that may comprise the scale ratio, and other characteristics associated with the scale 502 of the image 302 in which the object 122 is detected.

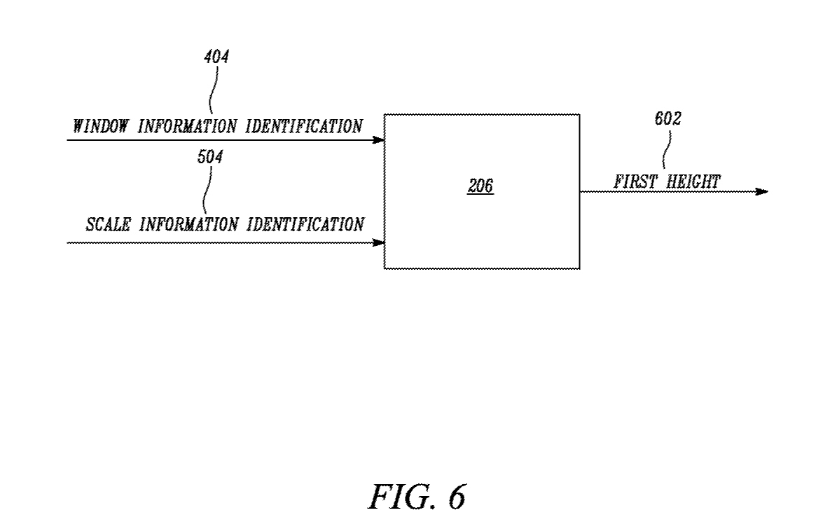

Referring to FIG. 2 and FIG. 6, the controller 202 further includes a first height determination module 206 to determine a first height 602 of the detected object 122. The first height determination module 206 receives the window information identification 404 of the detection window 402 in which the object 122 is detected and the scale information identification 504 of the scale 502 of the image 302 in which the object 122 is detected. The first height determination module 206 determines the first height 602 of the object 122 based on the window information identification 404 and the scale information identification 504. The first height determination module 206 may determine the first height 602 based on predefined equations including the window information identification 404 and the scale information identification 504.

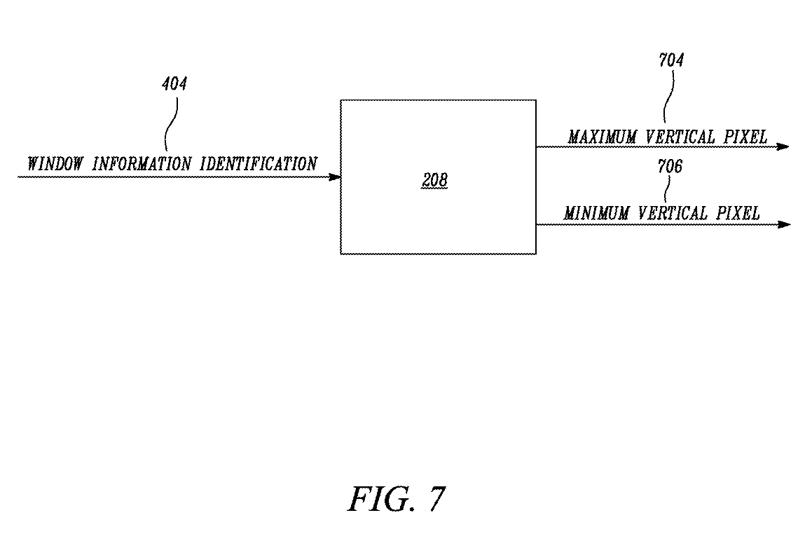

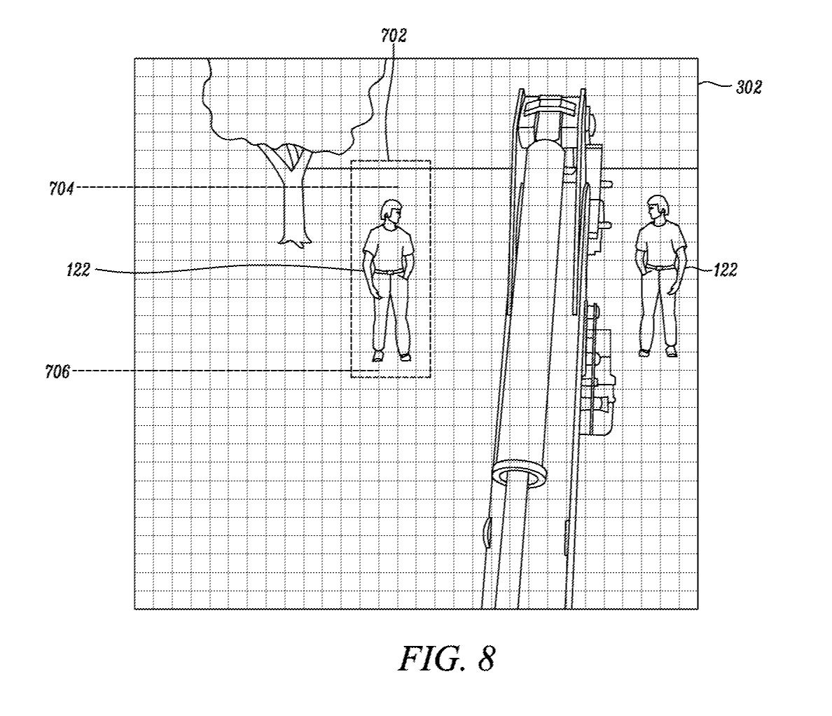

Referring to FIG. 2, the controller 202 further includes a bounding box determination module 208 configured to receive, from the detection module 204, the window information identification 404 of the detection window 402 in which the object 122 is detected. As shown in FIG. 7 and FIG. 8, the bounding box determination module 208 processes the window information identification 404 of the detection window 402 to determine a set of pixels or a detection bounding box 702 defining the object 122, that is detected. Subsequently, the bounding box determination module 208 determines a maximum vertical pixel 704, and a minimum vertical pixel 706 based on the detection bounding box 702. In this example, the image 302 has a pixel resolution of 30×30 resulting in a total of 900 pixels. A difference between the maximum vertical pixel 704 and the minimum vertical pixel 706 may correspond to a pixel height of the object 122 in the image 302.

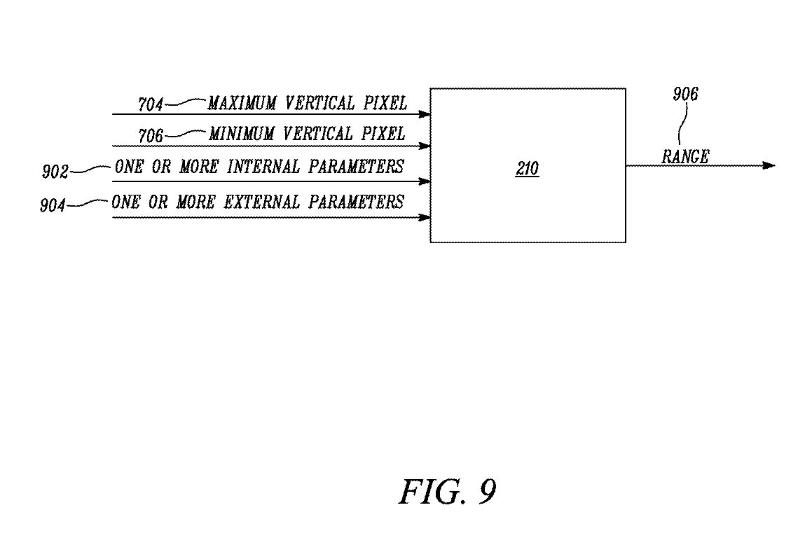

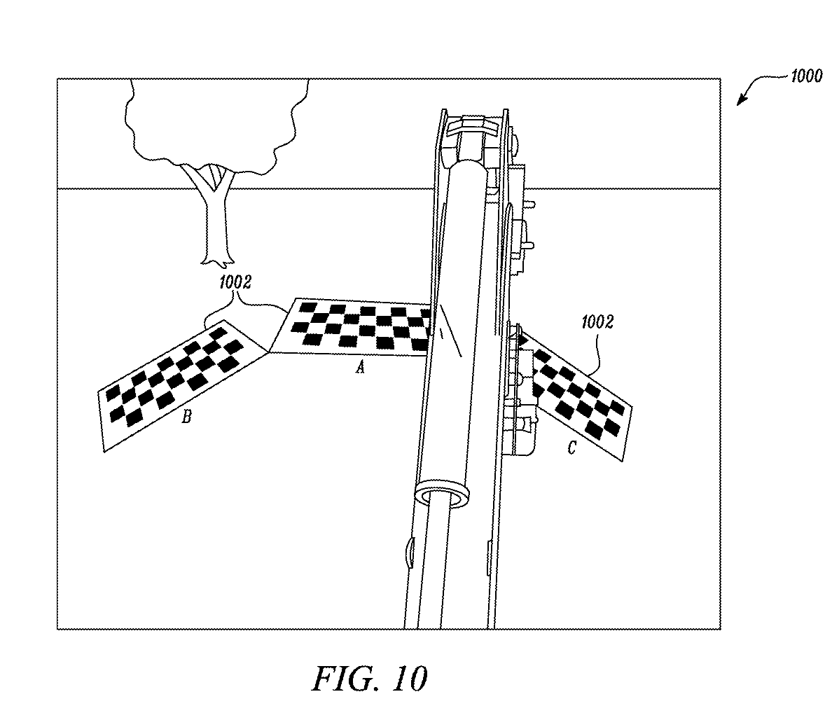

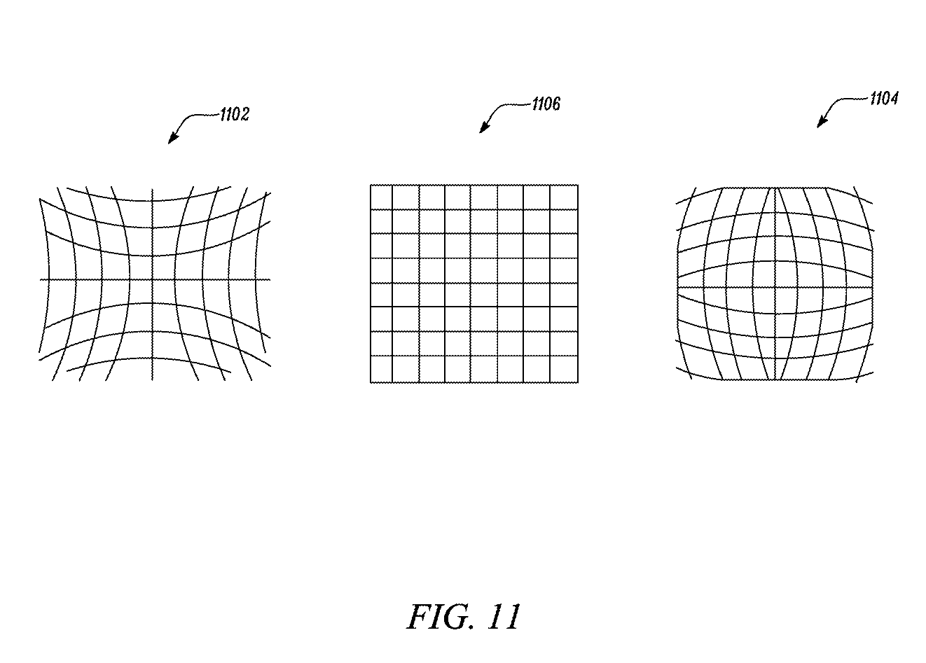

Referring to FIG. 2 and FIG. 9, the controller 202 includes a range determination module 210 configured to determine a range 906 of the object 122 detected in the image 302. For determining the range 906, the range determination module 210 receives one or more internal parameters 902 associated with intrinsic calibration of the image capturing device 120 and one or more external parameters 904 associated with extrinsic calibration of the image capturing device 120. FIGS. 10 and 11 explain the calibration process to obtain the one or more internal parameters 902 and the one or more external parameters 904.

FIG. 10 shows a system 1000 for calibration of the image capturing device 120. The system includes a pattern 1002 with known dimensions to calibrate the image capturing device 120. In one embodiment, the pattern 1002 used for intrinsic calibration is a two-dimensional (2D) checkerboard. A calibration process of the image capturing device 120 may be divided into an intrinsic calibration process and an extrinsic calibration process. The intrinsic calibration process includes calibration of the image capturing device 120 to calculate the one or more internal parameters 902 of the image capturing device 120. The one or more internal parameters 902 may comprise a focal length, an optical center, a pixel azimuth angle and a pixel elevation angle, etc. The extrinsic calibration process includes calibration of the image capturing device 120 to calculate the one or more external parameters 904 of the image capturing device 120. The one or more external parameters 904 may comprise a roll, a pitch, a yaw, an angle of depression with respect to a ground level, a horizontal position, and a vertical position of the image capturing device 120, etc.

To begin the calibration process, the pattern 1002 is placed on the ground in a position A as shown in the FIG. 10. The position A may be substantially in the middle of a field of view of the image capturing device 120. The image capturing device 120 captures one or more images comprising the pattern 1002 in the position A. To cover more points in the field of view, the pattern 1002 may be moved to different positions and different orientations such as left, right, up, and down with respect to the image capturing device 120. In some embodiments, the pattern 1002 may be tilted left, tilted right, moved towards the image capturing device 120 or moved away from the image capturing device 120. In the illustrated embodiment, the pattern 1002 is moved to a position B which is on a left side of the image capturing device 120 and a position C which is on a right side of the image capturing device 120. The image capturing device 120 may be configured to capture images corresponding to various positions and orientations of the pattern 1002 as shown in the FIG. 10.

The image capturing device 120 may include a calibration software to process the images captured during the calibration process. Alternatively, an external calibration software may be used to process the images captured during the calibration process.

In one embodiment, the images captured during the calibration process may be distorted due to one or more types of lens distortion. FIG. 11 shows typical examples of images 1102, 1104, and 1106 having positive radial distortion, negative radial distortion, and no distortion respectively. The images 1102, and 1104 illustrate negative radial distortion and positive radial distortion respectively. Radial distortion is due to light rays near the edges of lens of the image capturing device 120 bending more than the light rays at an optical center of the image capturing device 120. The image 1106 illustrates zero distortion. The image capturing device 120 may be configured to determine a lens distortion value to compensate for the distortion effects. In one embodiment, the one or more internal parameters 902 may also include the lens distortion value.

As shown in FIG. 9, the range determination module 210 is configured to receive the minimum vertical pixel 706 from the bounding box determination module 208. The range determination module 210 is further configured to receive the one or more internal parameters 902 associated with intrinsic calibration of the image capturing device 120 and the one or more external parameters 904 associated with extrinsic calibration of the image capturing device 120. The range determination module 210 may assume that the object 122 is standing on the ground and accordingly may determine the range 906 of the object 122 using the minimum vertical pixel 706, the one or more internal parameters 902 and the one or more external parameters 904.

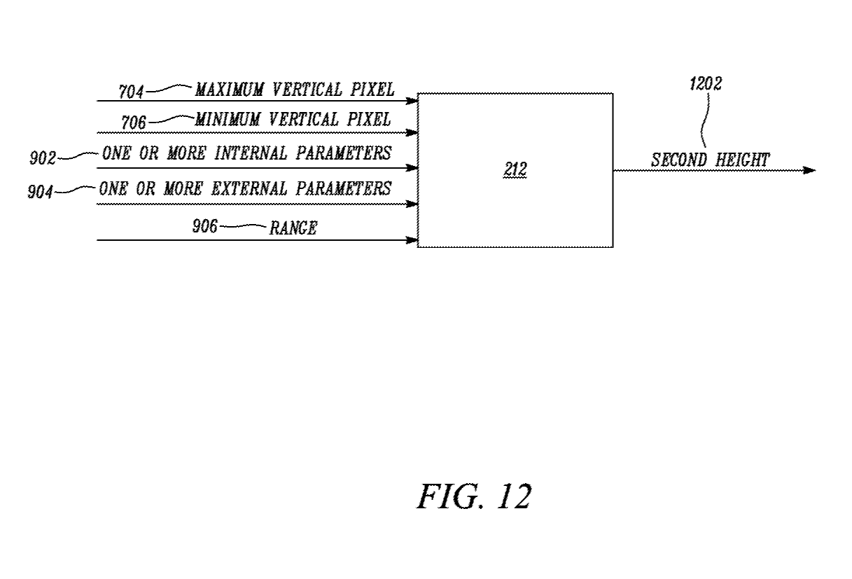

Referring to FIG. 2 and FIG. 12, the controller 202 further includes a second height determination module 212 configured to determine a second height 1202 of the object 122 detected in the image 302. As shown in FIG. 12, the second height determination module 212 receives the maximum vertical pixel 704 and the minimum vertical pixel 706 from the bounding box determination module 208 and the range 906 from the range determination module 210 to determine the second height 1202 of the object 122. To determine the second height 1202, the second height determination module 212 may first determine a pixel scale. The pixel scale represents a relationship between the pixel height and an estimated height of the object 122. The pixel scale may be configured as a lookup table including a list of different values of the pixel height and corresponding values of estimated height. In an exemplary embodiment, the lookup table may be used to determine the second height 1202 of the object 122 based on the pixel height i. e, the difference between the maximum vertical pixel 704 and the minimum vertical pixel 706.

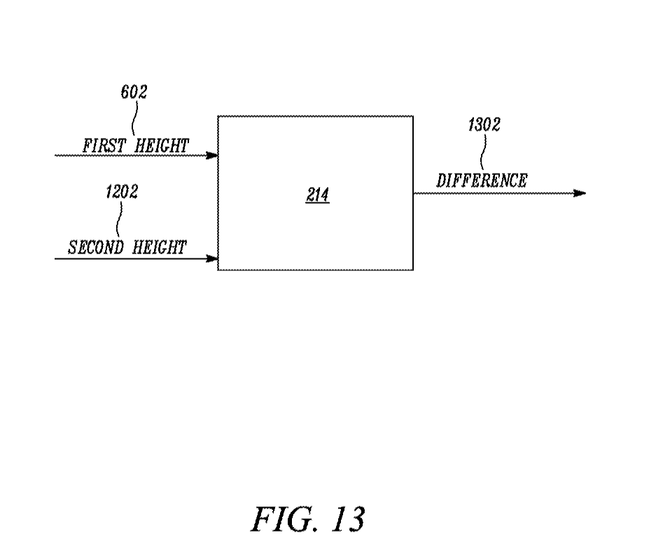

Referring to FIG. 2, the controller 202 further includes a height comparator 214 to compare the first height 602 determined by the first height determination module 206 and the second height 1202 determined by the second height determination module 212. As shown in FIG. 13, the height comparator 214, receives information pertaining to the first height 602 of the object 122 from the first height determination module 206 and information pertaining to the second height 1202 of the object 122 from the second height determination module 212. The height comparator 214 may compute a difference 1302 between the first height 602 and the second height 1202. Subsequently, the height comparator 214 compares the difference between the first height 602 and the second height 1202 with a predetermined criterion. In one embodiment, the predetermined criterion corresponds to the condition that the difference 1302 between the first height 602 and the second height 1202 of the object 122 is less than, equal to or higher than a predetermined percentage value.

Subsequently, the controller 202 modifies the score 304 based on whether the difference 1302 of the first height 602 and the second height 1202 meets the predetermined criterion. In one embodiment, if the difference 1302 between the first height 602 and the second height 1202 of the object 122 is higher than a predetermined percentage value, the controller 202 may decrease the score 304 representing a lower probability of the object 122, that is detected, having the predefined set of characteristics. Accordingly, the controller 202 may determine that the detection of the object 122 is a false alarm. On the other hand, if the difference 1302 between the first height 602 and the second height 1202 is less than or equal to the predetermined percentage value, the controller 202 may increase the score 304 representing a higher probability of the object 122, that is detected, having the predefined set of characteristics.

Subsequently, the controller 202 may inform the operator of the machine 100 by sending a warning about the modified score. The warning may include an audio warning or a visual warning. In an example, when the controller 202 determines that the detection of the object 122 is a false alarm, the audio warning may announce to the operator that the object 122, that is detected, in the image 302, does not match with the predefined set of characteristics, and thus, the operator may continue the operation of the machine 100. Similarly, the visual warning may show the information about the false alarm on the display 118 of the machine 100. In another example, when the controller 202 determines that the detection of the object 122 is accurate, the audio warning may announce to the operator that the object 122, that is detected, is in vicinity of the machine 100, based on the information obtained through the range 906, and ask the operator to take necessary actions. Similarly, the visual warning may show the information about the presence of the object 122 and the distance of the object 122 from the machine 100, based on the information obtained through the range 906.

### INDUSTRIAL APPLICABILITY

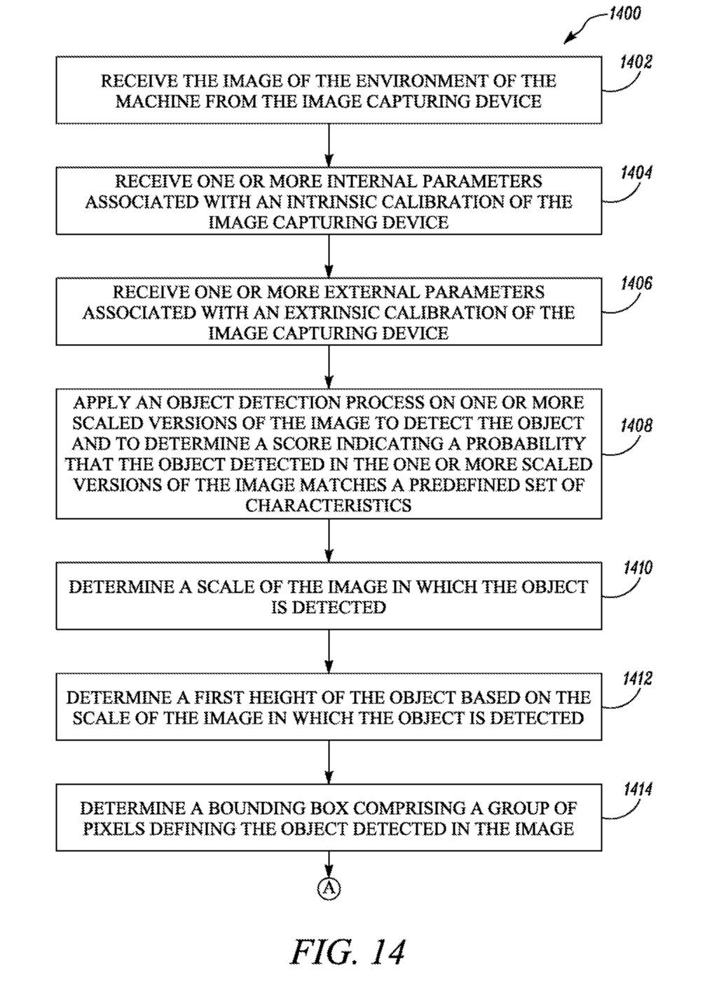

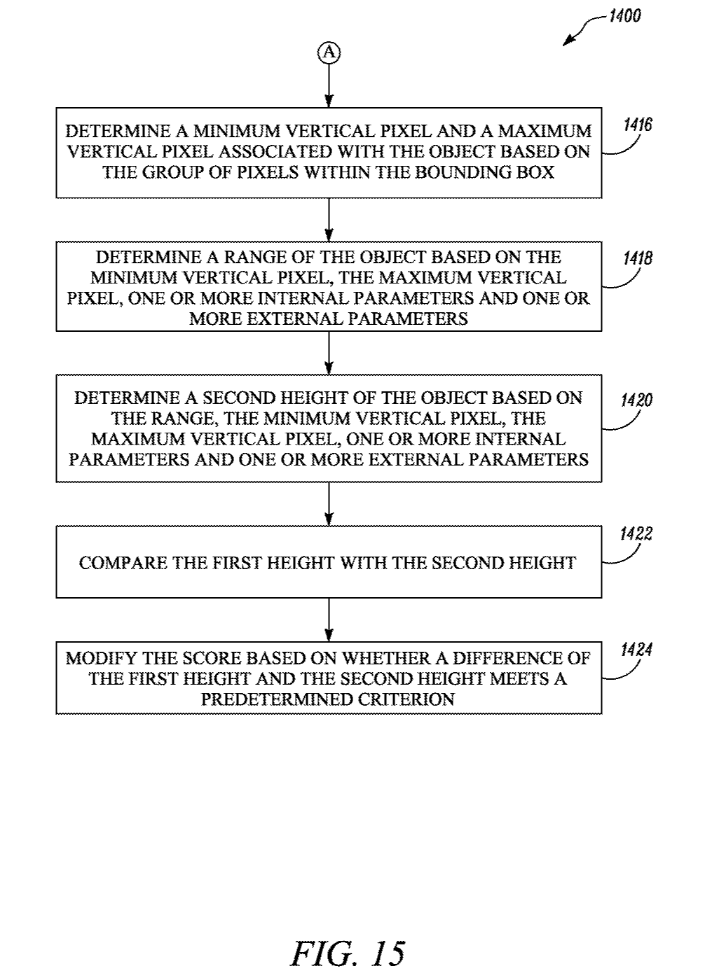

The present disclosure provides an improved method 1400 to detect the object 122 in the environment of the machine 100 as shown in FIG. 14 and FIG. 15.

The image capturing device 120 captures the image 302 of the environment of the machine 100. The image capturing device 120 may be a monocular camera. In block 1402, the controller 202 receives the image 302 of the environment of the machine 100 from the image capturing device 120. The image capturing device 120 is calibrated using the processes known in the art to determine the calibration parameters. In block 1404, the controller 202 receives the one or more internal parameters 902 associated with intrinsic calibration of the image capturing device 120. The one or more internal parameters 902 may comprise a focal length, an optical center, a pixel azimuth angle and a pixel elevation angle, etc. In block 1406, the controller 202 receives the one or more external parameters 904 associated with extrinsic calibration of the image capturing device 120. The one or more external parameters 904 may comprise a roll, a pitch, a yaw, an angle of depression with respect to a ground level, a horizontal position, and a vertical position of the image capturing device 120, etc.

In block 1408, the controller 202 applies the object detection process on one or more scaled versions of the image 302 to detect the object 122 and to determine the score 304 indicating a probability that the object 122, that is detected in the image 302, matches the predefined set of characteristics. In one embodiment, the object detection process is a sliding window detection process. The predefined set of characteristics include at least a height of a specific type of the object 122. In block 1410, the controller 202 determines the scale 502 of the image 302 and the corresponding scale information identification 504. The scale information identification 504 may comprise the scale ratio, and other characteristics associated with the scale 502 of the image 302 in which the object 122 is detected. In block 1412, the controller 202 determines the first height 602 of the object 122 based on the scale 502 of the image 302 in which the object 122 is detected.

In block 1414, the controller 202 determines the bounding box 702 comprising the group of pixels defining the object 122 detected in the image 302. The controller 202 processes the window information identification 404 of the detection window 402 to determine a set of pixels or the bounding box 702 defining the object 122, that is detected. In block 1416, the controller 202 determines the minimum vertical pixel 706 and the maximum vertical pixel 704 associated with the object 122 based on the group of pixels within the bounding box 702.

In block 1418, the controller 202 determines the range 906 of the object 122 based on the minimum vertical pixel 706, the one or more internal parameters 902 and the one or more external parameters 904. In block 1420, the controller 202 determines the second height 1202 of the object 122 based on the range 906, the minimum vertical pixel 706, the maximum vertical pixel 704, the one or more internal parameters 902 and the one or more external parameters 904.

In block 1422, the controller 202 compares the first height 602 and the second height 1202. In block 1424, the controller 202 modifies the score 304 based on whether the difference 1302 of the first height 602 and the second height 1202 meets the predetermined criterion. In one embodiment, if the difference 1302 between the first height 602 and the second height 1202 of the object 122 is higher than a predetermined percentage value, the controller 202 may decrease the score 304 representing a lower probability of the object 122, that is detected, having the predefined set of characteristics. Accordingly, the controller 202 may determine that the detection of the object 122 is a false alarm. Accordingly, the controller 202 may send a warning to the operator of the machine 100 informing that the object 122, having the predefined set of characteristics, is not detected in the image 302. The controller 202 may show such information on the display 118 of the machine 100 or inform the operator through the audio warning. This may enable the operator to continue the operation of the machine 100 and thus reduces a down time of the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for detecting an object in an environment of a machine, the method comprising:
capturing, through an image capturing device, an image of the environment of the machine;
receiving, using a controller, the image of the environment of the machine from the image capturing device;
receiving, using the controller, one or more internal parameters associated with an intrinsic calibration of the image capturing device;
receiving, using the controller, one or more external parameters associated with an extrinsic calibration of the image capturing device;
applying, through the controller, an object detection process on one or more scaled versions of the image to detect the object and to determine a score indicating a probability that the object detected in the one or more scaled versions of the image matches a predefined set of characteristics;
determining, through the controller, a scale of the image in which the object is detected;
determining, through the controller, a first height of the object based on the scale of the image in which the object is detected;
determining, through the controller, a bounding box comprising a group of pixels defining the object detected in the image;
determining, through the controller, a minimum vertical pixel and a maximum vertical pixel associated with the object based on the group of pixels within the bounding box;
determining, through the controller, a range of the object based on the minimum vertical pixel, the one or more internal parameters and the one or more external parameters;
determining, through the controller, a second height of the object based on the range, the minimum vertical pixel, the maximum vertical pixel, the one or more internal parameters and the one or more external parameters;
comparing, through the controller, the first height with the second height; and
modifying, through the controller, the score based on whether a difference between the first height and the second height meets a predetermined criterion.

2. The method of claim 1, wherein the one or more internal parameters include at least one of a focal length, a lens distortion value, a pixel azimuth angle or a pixel elevation angle.

3. The method of claim 1, wherein the one or more external parameters include at least one of a roll, a pitch, a yaw, an angle of depression with respect to a ground level, a horizontal position, or a vertical position of the image capturing device.

4. The method of claim 1, wherein the object detection process is a sliding-window detection process.

5. The method of claim 1, wherein the predefined set of characteristics is associated with one or more characteristics of a human.

6. The method of claim 1, wherein modifying the score comprises:
decreasing the score when the difference between the first height and the second height is higher than a predetermined percentage value; and
increasing the score when the difference between the first height and the second height is less than or equal to the predetermined percentage value range.

7. The method of claim 6 further comprising providing, using the controller, a visual warning on a display of the machine if the modified score indicates that the object detected in the image does not match the predefined set of characteristics.

8. An object detection system for detecting an object in an environment of a machine, the object detection system comprising:
an image capturing device configured to capture an image of the environment of the machine; and
a controller communicably coupled to the image capturing device, the controller configured to:
receive the image of the environment of the machine from the image capturing device;
receive one or more internal parameters associated with an intrinsic calibration of the image capturing device;
receive one or more external parameters associated with an extrinsic calibration of the image capturing device;
apply, through the controller, an object detection process on one or more scaled versions of the image to detect the object and to determine a score indicating a probability that the object detected in the one or more scaled versions of the image matches a predefined set of characteristics;
determine, through the controller, a scale of the image in which the object is detected;
determine, through the controller, a first height of the object based on the scale of the image in which the object is detected;
determine, through the controller, a bounding box comprising a group of pixels defining the object detected in the image;
determine, through the controller, a minimum vertical pixel and a maximum vertical pixel associated with the object based on the group of pixels within the bounding box;
determine, through the controller, a range of the object based on the minimum vertical pixel, the one or more internal parameters and the one or more external parameters;
determine, through the controller, a second height of the object based on the range, the minimum vertical pixel, the maximum vertical pixel, the one or more internal parameters and the one or more external parameters;
compare, through the controller, the first height with the second height; and
modify, through the controller, the score based on whether a difference between the first height and the second height meets a predetermined criterion.

9. The object detection system of claim 8, wherein the one or more internal parameters include at least one of a focal length, a lens distortion value, a pixel azimuth angle or a pixel elevation angle.

10. The object detection system of claim 8, wherein the one or more external parameters include at least one of a roll, a pitch, a yaw, an angle of depression with respect to a ground level, a horizontal position, or a vertical position of the image capturing device.

11. The object detection system of claim 8, wherein the object detection process is a sliding-window detection process.

12. The object detection system of claim 8, wherein the predefined set of characteristics is associated with one or more characteristics of a human.

13. The object detection system of claim 8, wherein the controller is configured to modify the score by:
decreasing the score when the difference between the first height and the second height is higher than a predetermined percentage value; and
increasing the score when the difference between the first height and the second height is less than or equal to the predefined percentage value.

14. The object detection system of claim 13, wherein the controller is further configured to provide an alert on a display of the machine if the modified score indicates that the object detected in the image does not match the predefined set of characteristics.

15. A machine comprising:
an undercarriage assembly,
an upper swiveling body supported on the undercarriage assembly;
an engine to provide power to propel the machine;
an image capturing device configured to capture an image of an environment of the machine, wherein the image capturing device is located onboard the machine;
a display configured to display the image of the environment of the machine; and
a controller communicably coupled to the image capturing device and the display, wherein the controller is configured to:
receive the image of the environment of the machine from the image capturing device;
receive one or more internal parameters associated with an intrinsic calibration of the image capturing device;
receive one or more external parameters associated with an extrinsic calibration of the image capturing device;
apply, through the controller, an object detection process on one or more scaled versions of the image to detect the object and to determine a score indicating a probability that the object detected in the one or more scaled versions of the image matches a predefined set of characteristics;
determine, through the controller, a scale of the image in which the object is detected;
determine, through the controller, a first height of the object based on the scale of the image in which the object is detected;
determine, through the controller, a bounding box comprising a group of pixels defining the object detected in the image;
determine, through the controller, a minimum vertical pixel and a maximum vertical pixel associated with the object based on the group of pixels within the bounding box;
determine, through the controller, a range of the object based on the minimum vertical pixel, the one or more internal parameters and the one or more external parameters;
determine, through the controller, a second height of the object based on the range, the minimum vertical pixel, the maximum vertical pixel, the one or more internal parameters and the one or more external parameters;
compare, through the controller, the first height with the second height; and
modify, through the controller, the score based on whether a difference between the first height and the second height meets a predetermined criterion.

16. The machine of claim 15, wherein the one or more internal parameters include at least one of a focal length, a lens distortion value, a pixel azimuth angle and a pixel elevation angle.

17. The machine of claim 15, wherein the one or more external parameters include at least one of a roll, a pitch, a yaw, an angle of depression with respect to a ground level, a horizontal position, and a vertical position of the image capturing device.

18. The machine of claim 15, wherein the object detection process is a sliding-window detection process.

19. The machine of claim 15, wherein the predefined set of characteristics is associated with one or more characteristics of a human.

20. The machine of claim 15, wherein the controller is further configured to provide an alert on the display of the machine if the modified score indicates that the object detected in the image does not match the predefined set of characteristics.
